(19) United States
(12) Patent Application Publication
(10) Pub. No.: US 2026/0000991 A1
(43) Pub. Date: Jan. 1, 2026

(54) LEADER-FOLLOWER HIERARCHY-BASED REINFORCEMENT LEARNING FRAMEWORK FOR NON-PLAYABLE CHARACTERS IN VIRTUAL DIGITAL ENVIRONMENTS

(71) Applicants: ADVANCED MICRO DEVICES, INC., Santa Clara, CA (US); ATI TECHNOLOGIES ULC, Markham (CA)

(72) Inventors: Alexander Walter Cann, Markham (CA); Zachariah Louis Vincze, Markham (CA); Ian Charles Colbert, San Diego, CA (US); Mehdi Saeedi, Markham (CA)

(21) Appl. No.: 18/759,063

(22) Filed: Jun. 28, 2024

(51) Int. Cl. A63F 13/67; A63F 13/56

(52) U.S. Cl. CPC A63F 13/67; A63F 13/56

(57) ABSTRACT

A processing system includes a plurality of hardware components and a non-playable character (NPC) management circuit. The NPC management circuit is configured to select at least one NPC of a plurality of NPCs in a virtual digital environment as a leader NPC and designate remaining NPCs of the plurality of NPCs as follower NPCs in response to the plurality of NPCs being assigned to a first NPC group. The NPC management circuit is further configured to configure the at least one leader NPC to make decisions using a machine learning-based policy. The NPC management circuit is also configured to provide a decision made by the at least one leader NPC to the follower NPCs.

### BACKGROUND

Non-Player Characters (NPCs) are elements in modern video games, digital environments, and various forms of virtual realities (all interchangeably referred to herein as “virtual digital environments”). NPCs contribute to the narrative aspect of games and significantly influence the user gameplay experience. Conventionally, NPCs are characters or objects in video games that are not controlled by a user. They are designed to enhance the gaming environment through various roles, such as providing information, assisting with navigation, contributing to the storyline, and the like. NPCs can be interactive or non-interactive with players and often serve as, for example, guides, adversaries, bystanders, or quest-givers in games.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system in accordance with some implementations.

FIG. 2 is a diagram illustrating a machine learning (ML) module employing a neural network for implementation by the processing system of FIG. 1 in accordance with some implementations.

FIG. 3 is a diagram illustrating a non-playable character (NPC) management circuit for implementation by the processing system of FIG. 1 in accordance with some implementations.

FIG. 4 is a diagram illustrating a multi-NPC group and individual NPC groups in accordance with some implementations.

FIG. 5 is a diagram illustrating splitting boundaries and merge boundaries for different types of NPC groups in accordance with some implementations.

FIG. 6 is a diagram illustrating an NPC moving outside of a splitting boundary of a multi-NPC group in accordance with some implementations.

FIG. 7 is a diagram illustrating the NPC of FIG. 6 being placed into an individual NPC group in response to moving outside of the splitting boundary of the multi-NPC group in accordance with some implementations.

FIG. 8 is a diagram illustrating multiple NPC moving outside of a splitting boundary of a multi-NPC group in accordance with some implementations.

FIG. 9 is a diagram illustrating the NPCs of FIG. 7 being placed into a new multi-NPC group in response to moving outside of the splitting boundary of their original multi-NPC group in accordance with some implementations.

FIG. 10 is a diagram illustrating the merge boundaries of two multi-NPC groups intersecting each other resulting in the two multi-NPC groups being merged into a single multi-NPC group in accordance with some implementations.

FIG. 11 is a diagram illustrating two individual NPC groups overlapping with a multi-NPC group without triggering the merging of these groups in accordance with some implementations.

FIG. 12 is a diagram illustrating an example of a reinforcement learning process implemented by a leader NPC to makes its decisions in a virtual digital environment in accordance with some implementations.

FIG. 13 is a diagram illustrating a decision-making process of a group of NPCs including leader NPCs and follower NPCs in accordance with some implementations.

FIG. 14 and FIG. 15 together are a flow diagram illustrating an overall process for managing NPCs in a virtual digital environment in accordance with some implementations.

FIG. 16 is a flow diagram illustrating an example method of a leader NPC of an NPC group making decisions in a virtual digital environment in accordance with some implementations.

FIG. 17 is a flow diagram illustrating an example method of a follower NPC of an NPC group making decisions in a virtual digital environment in accordance with some implementations.

### DETAILED DESCRIPTION

Recently, the use of machine learning (ML) in video games has significantly enhanced the intelligence and adaptability of non-playable characters (NPCs). These advancements have led to more realistic and engaging gaming experiences, as NPCs can now exhibit complex behaviors and respond dynamically to player actions. However, as games become more sophisticated and the demand for lifelike NPC interactions increases, developers face new challenges in managing the performance overhead associated with these advanced ML techniques. This is particularly evident when large numbers of NPCs are required to interact simultaneously within the game environment. Currently, NPCs powered by ML typically introduce significant performance overhead when incorporated into video games, particularly when deployed in large numbers. This presents a substantial challenge when aiming to create realistic and engaging games that feature crowds of NPCs. These crowds can include various entities such as pedestrians, enemies, or other interactive characters, and are a staple in many popular game genres.

Reinforcement learning (RL) is a prevalent ML approach that can be implemented individually or as a hybrid approach (e.g., RL combined with traditional methods, RL integrated with large language models (LLMs), and the like) to control NPC behavior. During the training phase, an RL agent, which in this context is an NPC, interacts with the game environment by collecting observations, performing actions, and receiving feedback in the form of rewards. The goal is to learn a policy that maximizes the cumulative expected reward, typically reflecting the accomplishment of specific tasks. After training, the learned policy is utilized during inference, where the NPC decides on the next actions based on current observations.

In the inference phase, the NPC periodically uses the trained model, often referred to as the policy or decision-making policy, to determine the optimal action at each step. This decision-making process occurs at a high frequency, potentially at every frame or every nth game tick (a specific interval in the game's update cycle), with common frequencies being 30 or 60 steps per second, or even higher depending on the game's requirements. At each step, the NPC observes the environment and computes the next action, which involves significant computational resources due to the complexity of current RL algorithms. These algorithms typically rely on neural networks, which are computationally intensive and require substantial memory operations.

The challenge escalates when managing multiple NPCs within the game environment. Each NPC needs to independently collect observations, run inference, and perform actions before the game progresses to the next state. Moreover, NPCs may utilize different model architectures with varying complexities, complicating the batching process, which is the process of grouping multiple inferences together to optimize computational resources, during inference calls. This can lead to non-trivial computational demands, impacting the overall performance and responsiveness of the game.

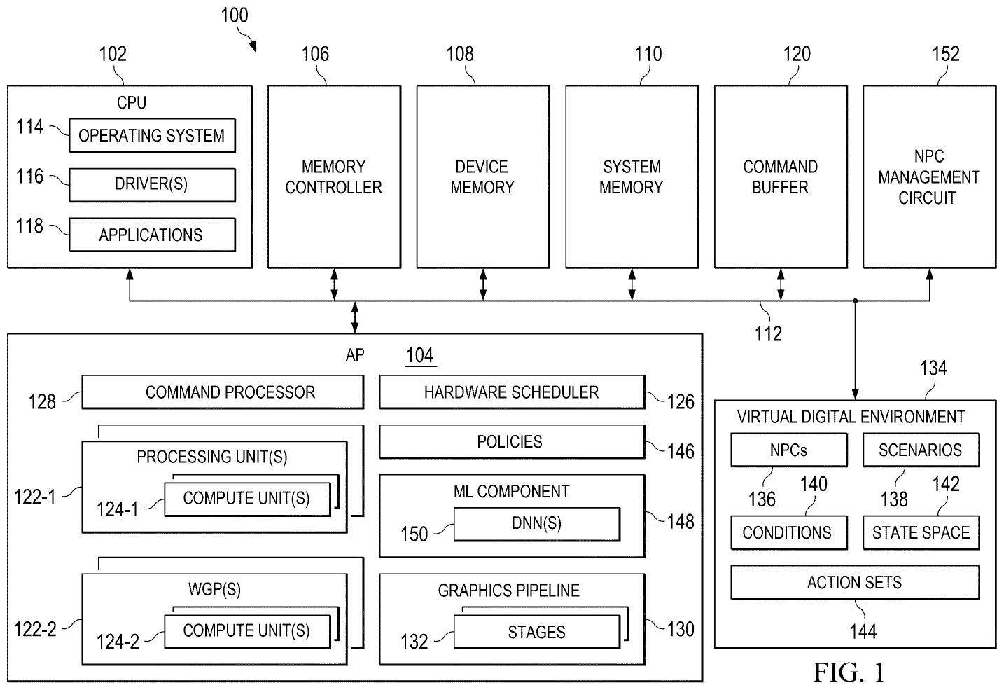

To address these problems and to efficiently manage crowds of DNN-based NPCs while reducing computational costs, FIG. 1 to FIG. 17 describe systems and methods for grouping and updating NPCs that include mechanisms for merging and splitting groups, as well as heuristics for optimizing follower updates. As described below, NPCs, in at least some implementations, are grouped together based on their proximity to each other, with each group having a leader and one or more followers. In at least some implementations, the initial assignment of NPCs to groups (also referred to as “crowds”) is dependent on how they are spawned into the virtual digital environment. For example, in games or other environments that spawn large groups of NPCs in close proximity at the same time, these NPCs are grouped into a single group. In another example, in games or other environments that spawn individual NPCs, these NPCs are be treated as having a one-NPC group.

In at least some implementations, techniques for managing groups are also implemented, including merging and splitting. Merging involves combining two or more groups into a single larger group, whereas splitting involves dividing a group into smaller sub-groups as NPCs move farther apart. For example, multiple boundaries, such as a merge boundary and a splitting boundary, are maintained for each group. The merge boundary starts a merge upon collision with another group's merge boundary, allowing NPCs to join or leave groups as they move closer together or further apart. The splitting boundary includes the merge boundary and determines when NPCs should be removed from the group and become a new smaller group.

The NPCs within a group are designated as one of two or more types, such as leaders and followers. Leaders are responsible for making their own decisions, whereas followers rely on the decisions made by the leaders in their group to make their own updates. For example, in at least some implementations, leaders make their own decisions using one or more machine learning algorithms, such as reinforcement learning (RL). The leaders' decisions are collected and distributed to their followers. Followers then use a heuristic function over the leaders' decisions to compute their own updates. For example, if there are five leaders in a group, they may each make a decision based on the game state, such as moving towards or away from the player. The followers would then use these decisions to compute their own actions, such as moving in a direction that is close to one of the leaders. These techniques allow for a reduction in the computational cost of processing large crowds of NPCs without impacting their perceived intelligence. For example, if there are one hundred NPCs in a group, only the leaders would need to collect observations and perform inference, while the followers would follow the leaders' decisions. In at least some implementations, one or more promotion and demotion mechanisms are implemented to adjust the leader-follower assignments as NPCs move or change their positions or behavior. For example, in some instances, when an NPC leaves a crowd or a group becomes too small, a follower is promoted to a leader. Also, in some instances, when a large group of NPCs forms, one or more leaders are demoted to followers.

As such, the techniques described herein reduce the bottleneck of NPC inference in virtual digital environments that use large numbers of DNN-based NPCs. By optimizing decision-making processes for groups of NPCs, rather than individual NPCs, the techniques improve overall performance without compromising the decision frequency or intelligence of each NPC. Furthermore, these techniques are applicable to various scenarios, including game development toolkits, where they can be used to train and optimize DNN-based NPCs for more realistic and engaging gameplay experiences. Moreover, although reinforcement learning is used as one example of machine learning utilized by NPCs to make decisions, the techniques described herein are applicable to NPCs implementing other machine learning techniques, such as large language models (LLMs), supervised learning, unsupervised learning, deep learning, decision trees, Bayesian networks, genetic algorithms, Markov decision processes (MDPs), offline machine learning techniques, and the like. The techniques described herein are also not limited to ML-based NPCs and are applicable to NPCs that implemented other AI techniques, such as behavior tree-based NPCs.

FIG. 1 is a block diagram illustrating a processing system 100 configured to manage NPCs and their decision-making processes in virtual digital environments. It is noted that the number of components of the processing system 100 varies from implementation to implementation. In at least some implementations, there is more or fewer of each component/subcomponent than the number shown in FIG. 1. It is also noted that the processing system 100, in at least some implementations, includes other components not shown in FIG. 1. Additionally, in other implementations, the processing system 100 is structured in other ways than shown in FIG. 1. Also, components of the processing system 100 are implemented as hardware, circuitry, firmware, software, or any combination thereof.

In the depicted example, the processing system 100 includes a central processing unit (CPU) 102, and one or more parallel processors, such as an accelerated processing device (APD) 104 (also referred to herein as “accelerated processing unit (APU) 104” or accelerated processor (AP) 104″), a memory controller 106, a device memory 108 utilized by the APD 104, and a system memory 110 shared by the CPU 102 and the APD 104. A parallel processor refers to any processing unit capable of executing multiple operations simultaneously. Examples of parallel processors include ADPs 104, graphics processing units (GPUs), general-purpose GPUs (GPGPUs), vector processors, non-scalar processors, highly-parallel processors, intelligence processing units (IPUs), neural processing units (NPUs), artificial intelligence (AI) processors, inference engines, machine learning processors, other multithreaded processing units, digital signal processors (DSPs), field programmable gate arrays (FPGAs), application-specific integrated circuits (ASICs), and the like.

APDs 104 are a type of parallel processor designed to enhance processing speed and efficiency for specific tasks. APDs 104 may include some of the aforementioned processors, such as GPUs, AI processors, inference engines, machine learning processors, IPUs, NPUs, and the like. APDs 104 may also include programmable logic devices such as field-programmable gate arrays (FPGAs), complex programmable logic devices (CPLDs), simple programmable logic devices (SPLDs), and the like. The CPU 102 and the APD 104, in at least some implementations, are formed and combined on a single silicon die or package to provide a unified programming and execution environment. In other implementations, the CPU 102 and the APD 104 are formed separately and mounted on the same or different substrates. In at least some implementations, the APD 104 is a dedicated GPU, one or more GPUs including several devices, or one or more GPUs integrated into a larger device.

The memory controller 106, in at least some implementations, includes any suitable hardware for interfacing with memories 108, 110. The memories 108, 110 include any of a variety of random access memories (RAMs) or combinations thereof, such as a double-data-rate dynamic random access memory (DDR DRAM), a graphics DDR DRAM (GDDR DRAM), high bandwidth memory (HBM), and the like. The APD 104 communicates with the CPU 102, the device memory 108, and the system memory 110 via a communications infrastructure 112, such as a bus. The communications infrastructure 112 interconnects the components of the processing system 100 and includes one or more of a peripheral component interconnect (PCI) bus, extended PCI (PCI-E) bus, advanced microcontroller bus architecture (AMBA) bus, advanced graphics port (AGP), or other such communication infrastructure and interconnects. In some implementations, communications infrastructure 112 also includes an Ethernet network or any other suitable physical communications infrastructure that satisfies an application's data transfer rate requirements.

As illustrated, the CPU 102 maintains, in memory, one or more control logic modules for execution by the CPU 102. The control logic modules, in at least some implementations, include an operating system 114, one or more drivers 116 (e.g., a user mode driver, a kernel mode driver, etc.), and applications 118. These control logic modules control various features of the operation of the CPU 102 and the APD 104. For example, the operating system 114 directly communicates with hardware and provides an interface to the hardware for other software executing on the CPU 102. The driver(s) 116, for example, controls the operation of the APD 104 by, for example, providing an application programming interface (API) to software (e.g., applications 118) executing on the CPU 102 to access various functionality of the APD 104. For example, in at least some implementations, an application 118 utilizes a graphics API to invoke a driver 116. The driver 116 issues one or more commands to the APD 104 for rendering one or more graphics primitives into displayable graphics images. Based on the graphics instructions issued by the application 118 to the driver 116, the driver 116 formulates one or more graphics commands that specify one or more operations for the APD 104 to perform for rendering graphics. In at least some implementations, the driver 116 is a part of the application 118 running on the CPU 102. In one example, the driver 116 is part of a gaming application running on the CPU 102. In another example, the driver 116 is part of the operation system 114 running on the CPU 102. The graphics commands generated by the driver 116 include graphics commands intended to generate an image or a frame for display. The driver 116 translates standard code received from the API into a native format of instructions understood by the APD 104. Graphics commands generated by the driver 116 are sent to the APD 104 for execution. The APD 104 executes the graphics commands and uses the results to control what is displayed on a display screen.

In at least some implementations, the CPU 102 sends graphics commands, compute commands, or a combination thereof intended for the APD 104 to a command buffer 120. Although depicted in FIG. 1 as a separate component for ease of illustration, the command buffer 120, in at least some implementations, is located in device memory 108, system memory 110, or a separate memory coupled to the communication infrastructure 112. The command buffer 120 temporarily stores a stream of graphics commands that include input to the APD 104. The stream of graphics commands includes, for example, one or more command packets and/or one or more state update packets.

The APD 104, in at least some implementations, accepts both compute commands and graphics rendering commands from the CPU 102. The APD 104 includes any cooperating collection of hardware, software, or a combination thereof that performs functions and computations associated with accelerating graphics processing tasks, data-parallel tasks, nested data-parallel tasks in an accelerated manner with respect to resources such as conventional CPUs, conventional GPUs, and combinations thereof. For example, in at least some implementations, the APD 104 executes commands and programs for selected functions, such as graphics operations and other operations that are particularly suited for parallel processing. In general, the APD 104 is frequently used for executing graphics pipeline operations, such as voxel operations, geometric computations, and rendering an image to a display. In some implementations, the APD 104 also executes compute processing operations (e.g., those operations unrelated to graphics such as video operations, physics simulations, computational fluid dynamics, etc.), based on commands or instructions received from the CPU 102. For example, such commands include special instructions that are not typically defined in the instruction set architecture (ISA) of the APD 104. In some implementations, the APD 104 receives an image geometry representing a graphics image, along with one or more commands or instructions for rendering and displaying the image. In various implementations, the image geometry corresponds to a representation of a two-dimensional (2D) or three-dimensional (3D) computerized graphics image.

In various implementations, the APD 104 includes one or more processing units 122 (illustrated as processing unit 122-1 and processing unit 122-2). One example of a processing unit 122 is a workgroup processor (WGP) 122-2. In at least some implementations, a WGP 122-2 is part of a shader engine (not shown) of the APD 104. Each of the processing units 122 includes one or more compute units 124 (illustrated as compute unit 124-1 and compute unit 124-2), such as one or more stream processors (also referred to as arithmetic-logic units (ALUs) or shader cores), one or more single-instruction multiple-data (SIMD) units, one or more single-instruction multiple-threads (SIMT) units, one or more logical units, one or more scalar floating point units, one or more vector floating point units, one or more special-purpose processing units (e.g., inverse-square root units, since/cosine units, or the like), a combination thereof, or the like. Stream processors are the individual processing elements that execute shader or compute operations. Multiple stream processors are grouped together to form a computer unit or a SIMD unit. SIMD units, in at least some implementations, are each configured to execute a thread concurrently with execution of other threads in a wavefront (e.g., a collection of threads that are executed in parallel) by other SIMD units, e.g., according to a SIMD execution model. The SIMD execution model is one in which multiple processing elements share a single program control flow unit and program counter and thus execute the same program but are able to execute that program with different data. The number of processing units 122 implemented in the APD 104 is configurable. Each processing unit 122 includes one or more processing elements such as scalar and or vector floating-point units, arithmetic and logic units (ALUs), and the like. In various implementations, the processing units 122 also include special-purpose processing units (not shown), such as inverse-square root units and sine/cosine units.

Each of the one or more processing units 122 executes a respective instantiation of a particular work item to process incoming data, where the basic unit of execution in the one or more processing units 122 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a processing unit 122.

The APD 104 issues and executes work-items, such as groups of threads executed simultaneously as a “wavefront,” on a single SIMD unit. Wavefronts, in at least some implementations, are interchangeably referred to as warps, vectors, or threads. In some implementations, wavefronts include instances of parallel execution of a shader program, where each wavefront includes multiple work items that execute simultaneously on a single SIMD unit in line with the SIMD paradigm (e.g., one instruction control unit executing the same stream of instructions with multiple data). Additionally, in a SIMT paradigm, each thread in a wavefront follows the same instruction sequence but operates on different data elements, allowing efficient parallel execution. A hardware scheduler (HWS) 126 is configured to perform operations related to scheduling various wavefronts on different processing units 122 and compute units 124, and performing other operations to orchestrate various tasks on the APD 104.

In at least some implementations, the processing system 100 also includes one or more command processors 128 that act as an interface between the CPU 102 and the APD 104. The command processor 128 receives commands from the CPU 102 and pushes the commands into the appropriate queues or pipelines for execution. The hardware scheduler 126 schedules the queued commands, also referred to herein as work items (e.g., a task, a thread, a wavefront, a warp, an instruction, or the like), for execution on the appropriate resources, such as the compute units 124, within the APD 104. In at least some implementations, the hardware scheduler 126 and the command processor 128 are separate components, whereas, in other implementations, the hardware scheduler 126 and the command processor 128 are the same component. Also, in at least some implementations, one or more of the processing units 122 include additional schedulers. For example, a WGP 122-2, in at least some implementations, includes a local scheduler (not shown) that, among other things, allocates work items to the compute units 124-2 of the WGP 122-2.

In at least some implementations, the APD 104 includes a memory cache hierarchy (not shown) including, for example, L1 cache and a local data share (LDS), to reduce latency associated with off-chip memory access. The LDS is a high-speed, low-latency memory private to each processing unit 122. In some implementations, the LDS is a full gather/scatter model so that a workgroup writes anywhere in an allocated space.

A graphics processing pipeline 130 accepts graphics processing commands from the CPU 102 and thus provides computation tasks to the one or more processing units 122 for execution in parallel. In at least some implementations, the graphics pipeline 130 includes a number of stages 132, each configured to execute various aspects of a graphics command. Some graphics pipeline operations, such as voxel processing and other parallel computation operations, require that the same command stream or compute kernel be performed on streams or collections of input data elements. Respective instantiations of the same compute kernel are executed concurrently on multiple compute units 124 in the one or more processing units 122 to process such data elements in parallel. As referred to herein, for example, a compute kernel is a function containing instructions declared in a program and executed on a processing unit 122 of the APD 104. This function is also referred to as a kernel, a shader, a shader program, or a program.

In at least some implementations, the processing system 100 includes one or more virtual digital environments 134 (also referred to herein as “environments 134”), such as video games, digital environments, or other forms of virtual realities. These environments 134 create immersive and interactive experiences that simulate real-world or fantastical scenarios, engaging users through rich visuals, dynamic soundscapes, and responsive gameplay. Among the elements in virtual digital environments 134 are Non-Player Characters (NPCs) 136, which enhance the narrative depth, gameplay mechanics, and overall user engagement. NPCs 136 are characters within a virtual digital environment 134 that are not controlled by players. NPCs 136 can perform various roles, such as allies, adversaries, guides, or bystanders, and be interactive or non-interactive with players.

Virtual digital environments 134 encompass various applications, ranging from entertainment and education to training and simulation. For example, video games offer players complex worlds filled with interactive elements and NPCs 136 that can act as allies, adversaries, or neutral entities. In these games, NPCs 136 enhance the storyline, provide quests, and interact with the player in meaningful ways. Other examples of virtual digital environments 134 include virtual realities, such as virtual reality (VR) environments and augmented reality (AR) environments, and interactive virtual environments, such as virtual meeting spaces, social platforms, and educational simulations. In VR environments, NPCs 136 can engage with users in lifelike manners, providing realistic and intuitive interactions. These NPCs 136 may simulate real human behaviors, offering training scenarios for fields such as medicine, aviation, or military applications. For instance, in medical training simulations, NPCs 136 can act as patients with various conditions, allowing trainees to practice diagnosis and treatment in a controlled yet realistic environment. In interactive virtual environments, NPCs 136 serve various roles, such as virtual assistants, instructors, or simulation participants, aiding users in navigating the environment and achieving their goals.

In at least some implementations, the virtual digital environment 134 implements machine learning (ML) and reinforcement learning (RL) to enhance the behavior and adaptability of NPCs 136. Traditionally, NPCs followed pre-scripted paths, or paths generated by path-finding algorithms, such as A*, and displayed limited interaction capabilities. However, ML techniques enable NPCs to learn from their interactions, adapt to player behaviors, and exhibit complex decision-making processes. This results in more engaging and unpredictable interactions, enhancing the realism and depth of the virtual digital environment 134. For example, in a video game, an NPC 136 using RL learns to navigate through dynamic obstacles or develop strategies to challenge the player effectively. In social VR platforms, NPCs 136 facilitate interactions by mediating conversations or guiding new users through the virtual space.

In the virtual digital environment 134, NPCs 136 interact with a set of scenarios 138 and conditions 140. The set of scenarios 138 refers to the various situations and contexts within the gaming environment that NPCs 136 may encounter, such as different levels or stages (e.g., a forest, a dungeon, a battlefield, or a marketplace). Conditions 140 include specific game states or events, such as day or night cycles, weather conditions, the presence of enemies or allies, or the completion of certain objectives. The environment 134 defines the state space 142 and possible actions 144 for NPCs 136. The state space 142 represents every possible configuration of the environment 134, including variables such as the NPC's location, health status, available resources, nearby entities, current objectives, and environmental factors. The possible actions 144 are the various decisions or moves the NPC 136 can make in response to the current state, such as moving to a new location, attacking or defending, interacting with objects or other characters, using items or abilities, and communicating with other NPCs or players. The environment 134 simulates various environment (e.g., game) dynamics and delivers rewards and penalties based on NPC actions, including predefined rules, real-time analysis, and adaptive feedback that evolves with NPC behavior. The environment 134 interfaces with one or both of the CPU 102 or the APD 104, facilitating the execution of RL or other machine learning algorithms and the real-time adaptation of NPC behaviors. This includes data exchange protocols, synchronization mechanisms, and any middleware that bridges the hardware and software components.

In relation to the virtual digital environment 134, the CPU 102 manages overall system control, data coordination, and high-level decision-making, handling tasks such as orchestrating the various components, managing system resources, and high-level virtual digital environment logic. The CPU 102 coordinates data flow between different parts of the system, including the APD 104, preprocessing data, and issuing commands for intensive computations. The APD 104 handles computationally intensive tasks, such as running machine learning (ML) and reinforcement learning (RL) algorithms, training models, and performing real-time updates to NPC decision-making policies (also referred to herein as “policies 146”), leveraging parallel processing capabilities to handle multiple NPCs 136 simultaneously. The virtual digital environment 134 provides the context for NPC interactions, including state space 142, action sets 144, and reward structures, sending state information and receiving action decisions from the CPU 102 and APD 104, processing feedback, and dynamically reflecting real-time updates to NPC behaviors.

In at least some implementations, the policies 146 for NPC decision-making are implemented and updated in the APD 104, which executes the RL or other machine learning or AI algorithms. The policies 146, in at least some implementations, are RL-based policies, large language model-based policies, offline machine-learning based policies, a combination thereof, and the like. Although FIG. 1 shows the policies 146 located within the APD 104, in other implementations, the policies 146 are stored in memory, such as the device memory 108 or system memory 110. The virtual digital environment 134 generates reward signals, providing feedback based on NPC actions. The CPU 102 interacts with the virtual digital environment 134 to manage game states, control signals, and high-level commands, while the APD 104 processes computationally intensive tasks related to ML and RL and sends real-time decisions back to the virtual digital environment 134. The virtual digital environment 134 provides feedback based on NPC actions, which is processed by the CPU 102 and the APD 104 to refine NPC behaviors for subsequent iterations, ensuring a dynamic and responsive gaming experience.

In at least some implementations, the APD 104 implements one or more ML components 148 (also referred to herein as “ML circuits 148”) to execute ML algorithms, update decision-making policies 146 for NPCs, and perform real-time inference calls. The ML component 148 enable the APD 104 to handle computationally intensive tasks, ensuring that NPCs 136 can learn from their interactions, adapt to player behaviors, and exhibit complex decision-making processes dynamically within the virtual digital environment 134. As discussed in greater detail below, the ML component 148, in at least some implementations, implements reinforcement learning or deep reinforcement learning. In these implementations, the ML component 148 uses one or more neural networks, such as deep neural network(s) (DNNs) 150, to represent the decision policies 146 (or value functions).

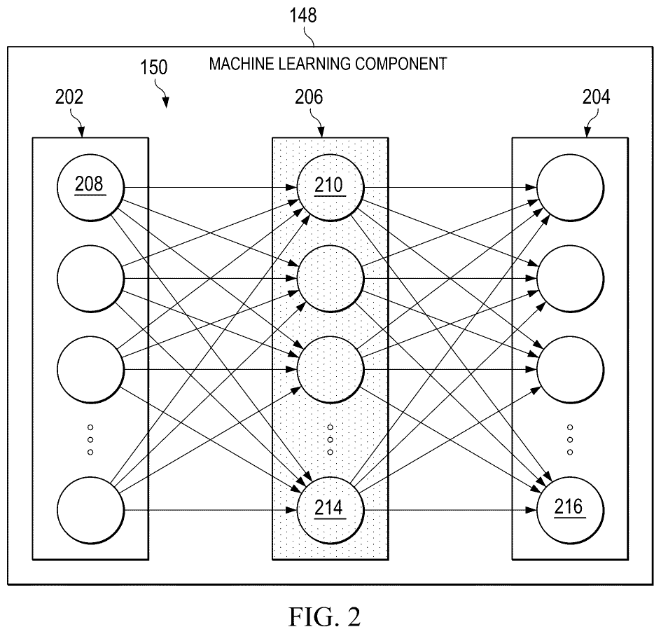

FIG. 2 shows one example of the ML component 148 implementing a neural network, such as a DNN 150, for NPC decision making. In the depicted example, the ML component 148 implements at least one deep neural network (DNN) 150 with groups of connected nodes (e.g., neurons and/or perceptrons) organized into three or more layers. The nodes between layers are configurable in a variety of ways, such as a partially connected configuration where a first subset of nodes in a first layer is connected with a second subset of nodes in a second layer, a fully connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based on adaptive learning. Using the DNN 150, the ML component 148 performs a variety of different types of analysis, including single linear regression, multiple linear regression, logistic regression, stepwise regression, binary classification, multiclass classification, multivariate adaptive regression splines, locally estimated scatterplot smoothing, a combination thereof, and so forth.

In at least some implementations, the DNN 150 is trained to output predicted actions for an NPC 136 to select. For example, the DNN 150 outputs a probability distribution over possible actions, such as moving left, right, forward, or backward. Alternatively, the DNN 150 outputs Q-values for each action, representing the expected cumulative reward for each action in the given state, or a scalar state-value indicating the expected reward from the current state. In another example, the DNN 150 simultaneously outputs both action probabilities and Q-values, enabling the NPC 136 to make decisions that optimize long-term rewards.

The DNN 150, in at least some implementations, is trained based on loss computation, backpropagation, and iterative processes. The ML component 148, in at least some implementations, uses one or both of statistical analysis and adaptive learning to map an input to an output. For instance, the ML component 148 uses characteristics learned from training data to correlate a previously unseen input to an output that is statistically likely within a threshold range or value. This allows the ML component 148 to receive complex inputs and identify corresponding outputs.

In the depicted example, the DNN 150 includes an input layer 202, an output layer 204, and one or more hidden layers 206 positioned between the input layer 202 and the output layer 204. Each layer has an arbitrary number of nodes, where the number of nodes between layers can be the same or different. That is, the input layer 202 can have the same number and/or a different number of nodes as output layer 204, the output layer 204 can have the same number and/or a different number of nodes than the one or more hidden layers 206, and so forth.

Node 208 corresponds to one of several nodes included in input layer 202, wherein the nodes perform separate, independent computations. As further described, a node receives input data and processes the input data using one or more algorithms to produce output data. Typically, the algorithms include weights and/or coefficients that change based on adaptive learning. Thus, the weights and/or coefficients reflect information learned by the neural network. Each node can, in some cases, determine whether to pass the processed input data to one or more next nodes. To illustrate, after processing input data, node 208 can determine whether to pass the processed input data to one or both of node 210 and node 212 of hidden layer 206. Alternatively, or additionally, node 208 passes the processed input data to nodes based upon a layer connection architecture. This process can repeat throughout multiple layers until the DNN 150 generates an output using the nodes (e.g., node 214) of output layer 204.

A neural network can also employ a variety of architectures that determine what nodes within the neural network are connected, how data is advanced and/or retained in the neural network, what weights and coefficients the neural network is to use for processing the input data, how the data is processed, and so forth. These various factors collectively describe a neural network architecture configuration, such as the neural network architecture configurations briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architecture configuration can include a variety of parameter configurations that influence how the DNN 150 or other neural network processes input data.

A neural network architecture configuration of a neural network can be characterized by various architecture and/or parameter configurations. To illustrate, consider an example in which the DNN 150 implements a convolutional neural network (CNN). Generally, a convolutional neural network corresponds to a type of DNN in which the layers process data using convolutional operations to filter the input data. Accordingly, the CNN architecture configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively, or additionally, the pooling parameter specifies how and where the neural network pools data in the layers of data processing. A pooling parameter that indicates “max pooling” configures the neural network to pool by selecting a maximum value from the grouping of data generated by the nodes of a first layer and using the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively, or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In some implementations, the weights and biases are learned parameter configurations, such as parameter configurations generated from training data. A layer parameter specifies layer connections and/or layer types, such as a fully-connected layer type that indicates to connect every node in a first layer (e.g., output layer 204) to every node in a second layer (e.g., hidden layer 206), a partially-connected layer type that indicates which nodes in the first layer to disconnect from the second layer, an activation layer type that indicates which filters and/or layers to activate within the neural network, and so forth. Alternatively, or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architecture configuration can include any suitable type of configuration parameter that a DNN can apply that influences how the DNN processes input data to generate output data. As such, the ML component 218 allows the NPC 136 to perform one or more machine learning operations for adjusting its behavior in real-time based on the current state of the virtual digital environment 134.

Referring again to FIG. 1, although machine learning has allowed NPCs 136 to exhibit more complex and dynamic behaviors, this shift toward more sophisticated NPCs, powered by machine learning techniques such as reinforcement learning, comes with significant demands on computational resources. As NPCs 136 leverage advanced algorithms to make real-time decisions, the processing power required increases substantially. Additionally, the process of collecting and processing observations from the game environment becomes more costly, further intensifying the computational load. This is especially true in scenarios where multiple NPCs must interact with each other and the environment simultaneously. Therefore, the processing system 100 includes an NPC management circuit 152 that groups NPCs 136 together into leaders and followers, manages these groups, and configures the leader NPCs 136 to implement reinforcement learning (RL) for their decision-making processes while configuring the follower NPCs 136 to use one or more heuristic functions to perform their decision-making processes based on the decisions of the leader NPCs 136.

As such, the NPC management circuit 152 improves efficiency in processing power utilization, reduces computational overhead, and enhances scalability. By grouping NPCs into leaders and followers, the NPC management circuit 152 is able to distribute the computational load effectively, allowing for smoother and more realistic simulations and reducing computation power compared to implementing NPCs that take unique actions. Additionally, the use of heuristics-based decision making for follower NPCs 136 enables them to adapt based on the decisions of leader NPCs 136 without requiring the same level of processing power, further reducing the overall computational burden. This results in a system that can handle large numbers of NPCs 136 with minimal impact on performance. It should be understood that although FIG. 1 shows the NPC management circuit 152 as a separate component, in at least some implementations, one or more components of the NPC management circuit 152 are implemented within the CPU 102, APD 104, or are distributed across the CPU 102 and the APD 104.

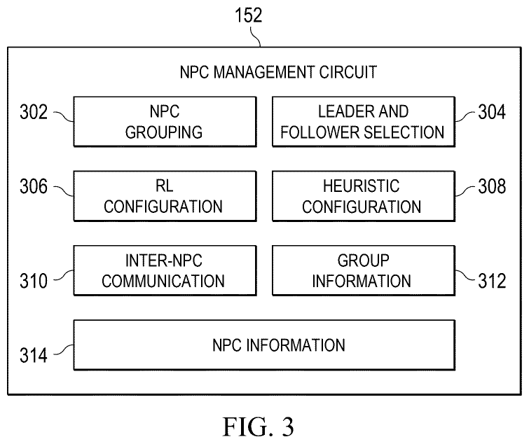

FIG. 3 shows a more detailed view of the NPC management circuit 152. In at least some implementations, the NPC management circuit 152 implements an NPC grouping process 302, a leader and follower selection process 304, an RL configuration process 306, a heuristic configuration process 308, an inter-NPC communication process 310. The NPC management circuit 152 also maintains group information 312 and NPC information 314. The NPC grouping process 302 groups multiple NPCs 136 into one or more groups. A group (e.g., crowd) is a collection of NPCs 136 that share a decision-making process. There can be any number of NPCs 136 in a group such that the group has a least one NPC 136. In at least some implementations, every NPC 136 that can form a group is considered a member of some group. As described below a group can either shrink as NPCs 136 spread out or grow as multiple groups of NPCs 136 get close together. Also, in at least some implementations, a fixed number of empty groups is defined and one or more NPCs 136 are assigned to these groups as the NPCs 136 are generated.

In at least some implementations, the NPC grouping process 302 initially groups NPCs 136 into a group based on one or more initial grouping policies or configurations. As an example, in at least some implementations, the NPC grouping process 302 assigns NPCs 136 to an initial group based on one or more spawning characteristics of the NPCs 136, such as being spawned as part of a group or spawned as an individual. For example, a virtual digital environment 134 with large groups of NPCs 136 often spawn the NPCs 136 in close proximity at the same time. Therefore, in at least some implementations, the NPC grouping process 302 initially assigns NPCs 136 that are spawned within a threshold amount of time to each other and within a threshold proximity of each other to the same group. However, in some instances, a virtual digital environment 134 spawns NPCs 136 individually. Therefore, in at least some implementations, the NPC grouping process 302 groups these individual NPCs 136 into their own separate group. In another example, the NPC grouping process 302 randomly assigns an NPC 302 to an initial group.

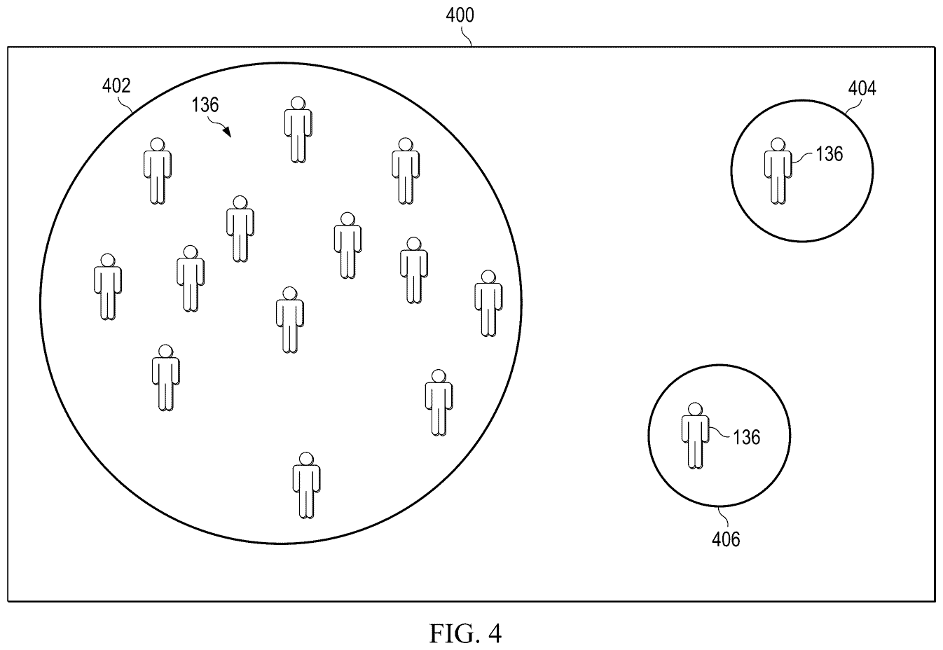

FIG. 4 shows various examples of grouping NPCs 136 together in virtual digital environment 400. As depicted, multiple NPCs 136 have been grouped together in a single NPC group 402. In this example, the NPC grouping process 302 initially grouped these NPCs 136 together because they were spawned within a threshold amount of time to each other and within a threshold proximity of each other. FIG. 4 also shows that a first NPC 136 has been grouped into its own individual group 404 (e.g., a single-NPC group) and a second individual NPC 136 has been grouped into its own individual group 406. In this example, the NPC grouping process 302 initially grouped the first individual NPC 136 and the second individual NPC 136 into their own separate groups 404, 406 because they were spawned outside of a threshold amount of time from other NPCs 136, outside a threshold proximity to other NPCs 136, or a combination thereof.

In at least some implementations, when the NPC management circuit 152 assigns an NPC 136 to a group, the NPC management circuit 152 updates the group information 312 to include characteristics or attributes of the group, such as a unique identifier (ID) associated with the group, the number of NPCs 136 currently in the group, a unique ID of each NPC 136 within the group, coordinates or voxels defining a boundary encompassing the group, coordinates or voxels indicating the current location of the group within the environment 134, a center position of the group, and the like. In at least some implementations, a geometric shape, such as a circle, is used to define a boundary or area within the environment 134 encompassing the group. In these implementations, the circle's center and radius (or equivalent) are recorded as part of the group information 312 to represent the group's spatial bounds. The NPC management circuit 152, in at least some implementations, determines the center position of the group by aggregating the positions of two or more members of the group. In at least some implementations, calculates the mean position of all leaders (described below) in the group and uses this mean position as the center position of the group.

The NPC management circuit 152, in at least some implementations, also updates the NPC information 314 when an NPC 136 is assigned to a group. For example, the NPC management circuit 152 updates the NPC information 314 to include the unique ID of the NPC 136, the unique ID of the group the NPC 136 is assigned to, an indication whether the NPC 136 is a leader or a follower (described below), coordinates or voxels representing the current location of the NPC 136 within the environment 134, coordinates or voxels representing the current location of the NPC 136 in relation to the center of the group, a pointer to the group information 312 associated with the NPC's group, and the like.

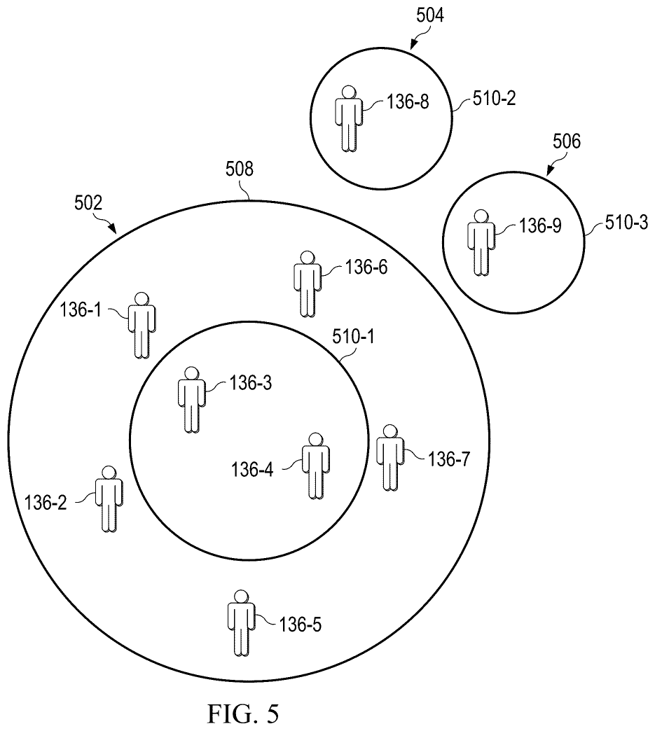

In at least some implementations, each group is defined by at least one boundary that encompasses all NPCs 136 within that group. For example, FIG. 5 shows that a first NPC group 502 (including NPCs 136-1 to 136-7) is associated with multiple boundaries 508 and 510 (illustrated as boundary 510-1) and each of a second NPC group 504 (including NPC 136-8) and a third NPC group 506 (including NPC 136-9) are associated with a single boundary 510 (illustrated as boundary 510-2 and boundary 510-3). The first boundary 508 defined for a multi-NPC group, such as the first NPC group 502, is referred to as a “splitting boundary 508”. The second boundary 510 defined for a multi-NPC group and an individual NPC group, such as the second NPC group 504 and the third NPC group 506, is referred to as a “merge boundary 510. Individual NPC groups, in this example, do not have a splitting boundary 508.

In at least some implementations, the splitting boundary 508 of an NPC group is characterized by the number of member NPCs and the center of the group (e.g., a circle where the center point is the average position of all the leaders, and the circle's radius is a linear function of the number of member NPCs). In at least some implementations, the splitting boundary 508 of a multi-NPC group strictly contains the merge boundary 510 of the multi-NPC group. Also, the merge boundary 510 of a multi-NPC group does not necessarily include all of the NPCs 136 of the of the multi-NPC group and, in some instances, may include no NPCs 136.

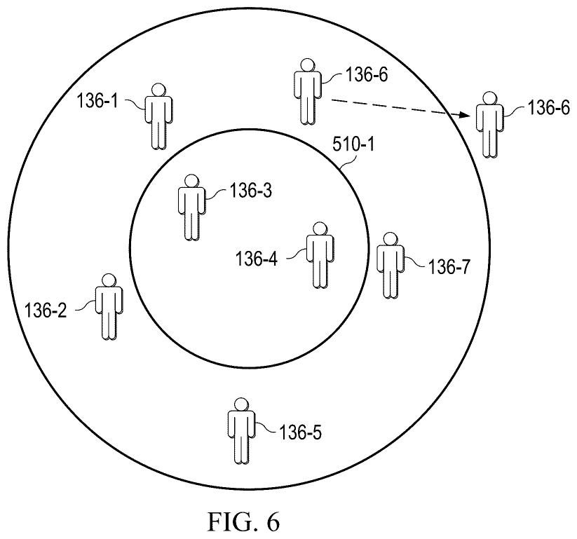

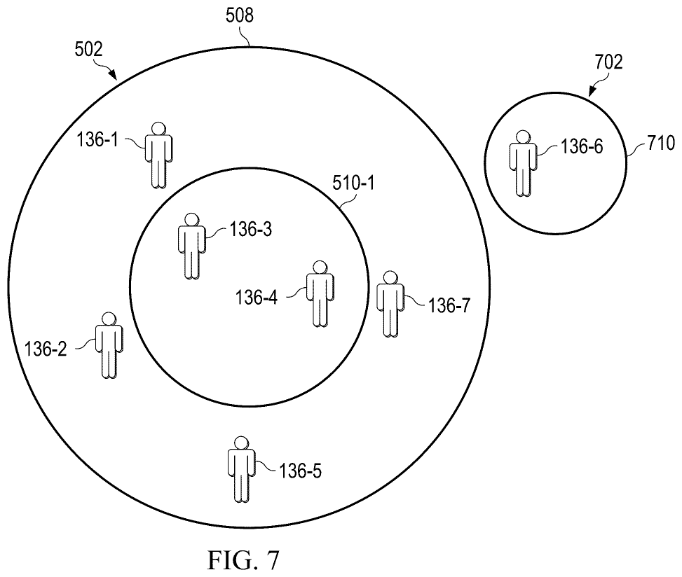

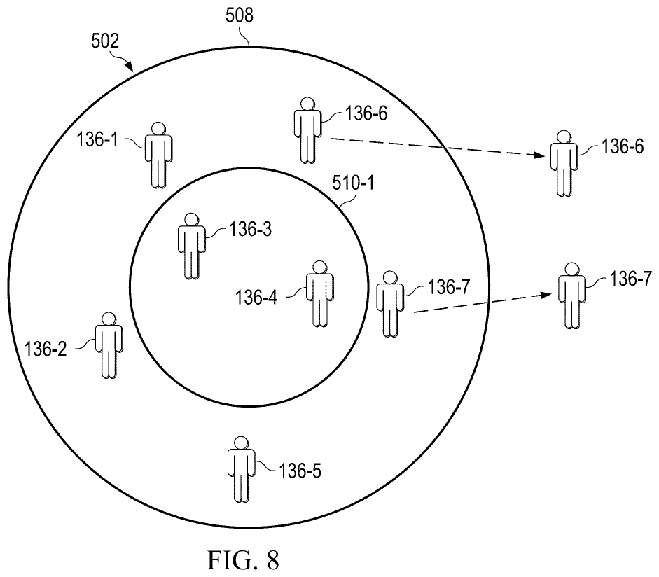

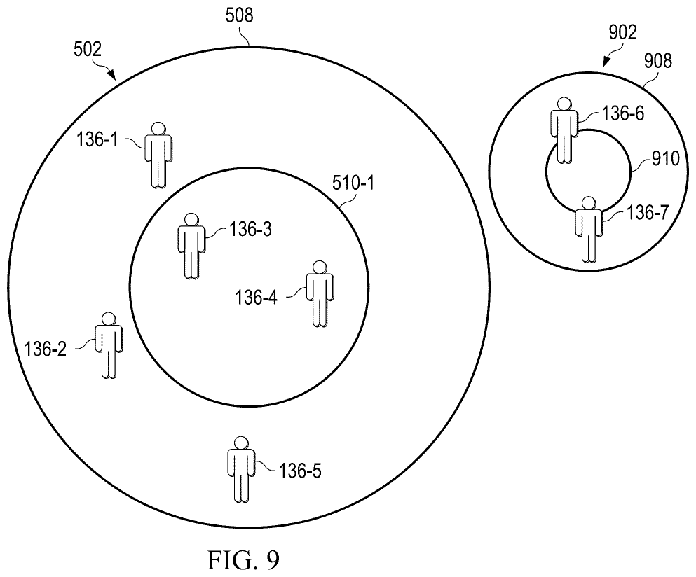

The NPC management circuit 152 monitors the movement and positions of the NPCs 136 within the multi-NPC group, and if an NPC 136 moves outside the splitting boundary 510, either because the center of the group moved or because the NPC 136 moved, the NPC grouping process 302 removes the NPC 136 from its current group and places this NPC 136 into a new smaller group, such as its own individual group. For example, FIG. 6 shows that NPC 136-6 has moved outside of the splitting boundary 510, as represented by the dashed arrow, and FIG. 7 shows that the NPC grouping process 302 has assigned NPC 136-6 to its own individual NPC group 702 defined by a merge boundary 710. If multiple NPCs 136 move outside the splitting boundary 510 and are within a threshold distance from each other, the NPC grouping process 302 groups these NPCs 136 together in a new multi-NPC group. For example, FIG. 8 shows that NPC 136-6 and NPC 136-7 have both moved outside of the splitting boundary 510, as represented by the dashed arrows. In this example, because NPC 136-6 and NPC 136-7 are within a threshold proximity of each other, the NPC grouping process 302 has assigned NPC 136-6 and NPC 136-7 to the same multi-NPC group 902 defined by a split boundary 908 and a merge boundary 910, as shown in FIG. 9.

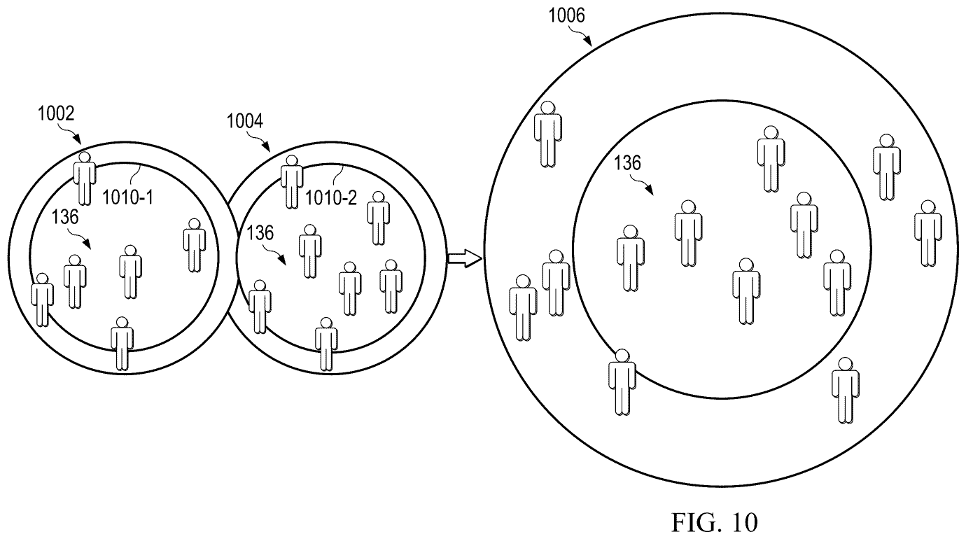

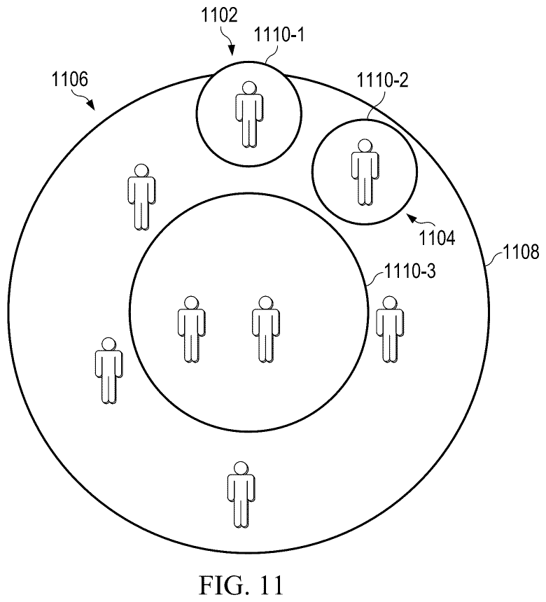

The NPC management circuit 152 also monitors the proximity of NPCs groups with respect to each to determine if two or more groups should be merged. In at least some implementations, the NPC management circuit 152 monitors the coordinates or tracks the voxels of each NPC group's merge boundaries 510 to determine if any merge boundaries 510 are intersecting or colliding. For example, FIG. 10 shows that a merge boundary 1010-1 of a first group 1002 of NPCs 136 is intersecting the merge boundary 1010-2 of a second group 1004 of NPCs 136. Therefore, the NPC grouping process 302 merges these two groups into a single group 1006 of NPCs 136. In some instances, two or more NPC groups overlap but do not satisfy one or more criteria for merging, such as their merge boundaries intersecting. For example, FIG. 11 shows a first NPC group 1102 and a second NPC group 1104 overlapping with a third NPC group 1106. However, because the merge boundary 1110-1 of the first NPC group and the merge boundary 1110-2 of the second NPC group 1104 do not intersect the merge boundary 1110-3 of the third NPC group 1106, the NPC grouping process 302 does not merge these NPC groups together. In at least some implementations, the NPC grouping process 302 reduces the overhead of checking for groups collisions by only checking a portion of the groups for collisions at a time.

The leader and follower selection process 304 (also referred to herein as the “selection process 304”) selects one or more leaders for the NPC group and designates the remaining NPCs 136 as followers of the selected leaders. If a group only has one NPC 136, then that NPC 136 is designated as a leader. A leader is an NPC 136 that makes its own decisions as if there was no group system. A follower is an NPC 136 that uses the decisions of the leaders, or a subset of the leaders, in its group to make decisions. In at least some implementations, the selection process 304 also designates one or more NPCs 136 as a sub-leader. A sub-leader, in at least some implementations, is an NPC that uses a decision-making process similar to that of the leaders but either takes the decisions of one or more leaders as an input or combines the decisions of one or more leaders with the output of the sub-leaders decision making process. In at least some implementations, a sub leader uses a decision-making process that is more computationally efficient than a full leader (e.g., a DNN architecture with less capacity). Therefore, selecting sub-leader allows the system to improve the number of leaders in the group without incurring the full overhead of adding full leaders.

The selection process 304 implements one or more mechanisms for determining which of the NPCs 136 should be a leader (and sub-leader if implemented). In one example, the selection process 304 randomly selects NPCs 136 within a group as a leader. In another example, the selection process 304 uses one or more characteristics or attributes of the NPCs 136 to determine which NPC 136 should be a leader. For example, the selection process 304 considers factors such as the position, velocity, and acceleration of each NPC 136, as well as their proximity to other NPCs 136 in the group. In addition, the selection process 304, in at least some implementations, uses a heuristics or rules-based approaches to select leaders based on certain conditions or scenarios. For instance, the selection process 304 prioritizes NPCs 136 that are closest to a target location or object, or those that have the highest probability of achieving a specific goal or objective. The selection process 304, in at least some implementations, utilizes techniques such as k-means clustering or density-based spatial clustering of applications with noise (DBSCAN) to identify natural group leaders based on their spatial and velocity distributions. In yet another example, the selection process 304, in at least some implementations, uses a combination of these mechanisms to select leaders, such as randomly selecting an NPC 136 from a group and then using characteristics or attributes to validate or override the selection. The specific mechanism used, in at least some implementations, depends on the requirements and constraints of the virtual digital environments 134 and the desired behavior of the NPCs 136.

As indicated above, a leader NPC and, in some instances a sub-leader NPC, makes its own decisions on what actions to take based on the current state of the virtual digital environment 134. In at least some implementations, the RL configuration process 306 configures a leader or sub-leader NPC 136 to utilize machine learning, such as reinforcement learning, to make decisions autonomously. When implementing RL, the virtual digital environment 134 is modeled with defined states, actions, and rewards. States represent various configurations or conditions of the environment 134, such as the NPC's location, health, and nearby entities. Actions are the possible moves or decisions the NPC 136 can take, such as moving forward, attacking, defending, or gathering resources. Rewards are feedback signals that guide the learning process, such as a positive reward for defeating an enemy or a negative reward for losing health. A suitable RL algorithm, such as Q-Learning, Deep Q-Network (DQN), or Proximal Policy Optimization (PPO), is selected. In complex environments, deep learning models, such as neural networks, are used to approximate optimal value functions or policies.

During the training phase, the NPC 136 interacts with the environment 134 repeatedly. At each time step, the NPC 136 observes the current state, selects an action based on a policy (initially random), receives a reward, and observes the next state. The RL algorithm updates the policy or value function based on these experiences, and this process continues until the NPC's behavior improves, achieving better rewards over time. Once the model is trained, it is saved and loaded into the runtime environment of the virtual digital environment 134 for deployment as one or more policies 146. At the start of the simulation (e.g., a game), the initial state of the environment 134 and the NPC's initial state are set up, such as the starting position and initial condition.

During interaction with the environment 134, the NPC 136 makes decisions in real-time based on the current state of the environment 134 using the decision-making policy or policies 146 resulting from the training process. In at least some implementations, the NPC 136 performs a decision making task at, for example, every frame, every nth game tick, or other frequency. This decision-making process involves making inference calls to the APD 104. The NPC observes the current state, preprocesses it to be compatible with the model's input requirements, and feeds the preprocessed state into the neural network model, such as a DNN 150, loaded on the APD 104. The model processes the input and outputs a set of action values or probabilities. For example, in a DQN, the output might be Q-values for each possible action, whereas in a policy-based model, the output could be probabilities of taking each action.

Based on the output from the model, the NPC 136 selects an action. If using a greedy policy, the action with the highest value or probability is chosen, whereas an ε-greedy policy might be used to balance exploration and exploitation. The NPC 136 then performs the chosen action in the environment 134. The environment 134 updates based on the NPC's action, leading to a new state. The NPC 136 observes this new state, and the process repeats. In at least some implementations, the NPC 136 continues learning and improving during actual gameplay through online learning, periodically updating the model based on new experiences gathered during the game. The NPC's performance is monitored, and feedback is collected to refine the model if necessary.

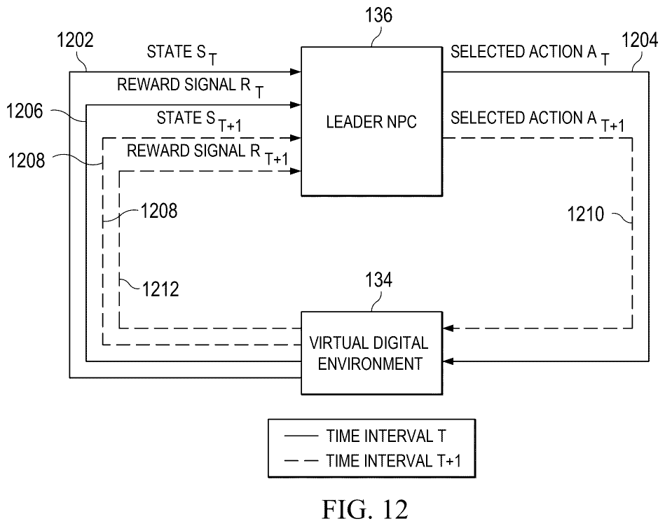

FIG. 12 a diagram of the decision-making process performed by a leader NPC 136 using RL. In this example, the environment 134 is a gaming environment, and the actions are decisions made by the NPC 136, such as moving, gathering resources, or interacting with other entities. However, it should be understood that the techniques described herein for decision making by a leader, or sub-leader, NPC 136 are applicable to any simulated environment or decision-making scenario.

During time interval T, the NPC 136 observes the current state, S_{T} 1202, of the environment 134. In this example, the state S_{T} 1202 includes the current position of the NPC, the health status of the NPC, and the presence of nearby entities, such as resources or other NPCs. The NPC 136 selects one or more actions, A_{T} 1204, based on the state S_{T} 1202 of the environment 134 and one or more learned policies 146. The NPC 136 then performs the selected actions. For example, the NPC 136 might move to a new location, gather resources, or interact with another NPC 136. Therefore, in this example, the NPC's actions are based on its current understanding and learned policies 146 to maximize rewards in the environment 134.

After the NPC 136 performs the selected actions, the environment 134 updates to reflect the impact of these actions. For example, if the NPC 136 gathers resources, the resources might be removed from the environment 134, or if the NPC interacts with another NPC 136, their relationship might be affected. Based on these changes, the environment 134 provides feedback in the form of a reward signal, R_{T} 1206. The reward signal R_{T} 1206 indicates the outcome of the NPC's actions, such as gaining points for collecting resources or improving relationships. The ML component 148 of the APD 104 then updates the decision-making policy 146 based on the reward signal R_{T} 1206 to improve future decision-making. In at least some implementations, the reward signal is provided only after certain states are reached and not after every action, such as gathering resources requiring 5 actions but only the last one provides reward to the agent, reflecting a sparse reward scenario.

During a subsequent time interval, T+1, the NPC 136 observes a new current state, S_{T+1} 1208, of the environment 134. In this example, the state S_{T+1} 1208 includes updated information such as the new position of the NPC 136, its current health status, and the status of nearby entities. The NPC 136 then selects one or more actions, A_{T+1} 1210, based on the current state S_{T+1} 1208 of the environment 134 and one or more learned policies 146. The NPC 136 then performs the selected actions. For example, the NPC 136 might again move, gather resources, or interact with other NPCs 136 based on the new state. After the NPC 136 performs the actions, the environment 134 updates, and a new reward signal, R_{T+1} 1212, is provided to the NPC 36. The ML component 148 of the APD 104 then updates the policy 146 based on the reward signal R_{T+1} 1212. The above process is then repeated for a subsequent time intervals.

When a leader NPC 136 makes a decision, the inter-NPC communication process 310 communicates this decision to each of the follower NPCs 136 or sub-leader NPCs 136. Follower and sub-leader NPCs 136 are configured by the heuristic configuration process 308 to use one or more heuristic functions to make decisions (e.g., select one or more available actions) based on the decision(s) made by their leader NPC 136. An example of a heuristic function implemented by a follower NPC 136 includes a moving average with distance instead of time. This heuristic function prioritizes decisions based on proximity to the leader NPC 136. The closer the follower NPC 136 is to the leader, the more influence its decision has on the follower's choice. Stated differently, the decisions of leaders that are closer to the follower NPC 136 are given more weight than the decisions of leaders that are farther from the follower NPC 136. Another example of a heuristic function implemented by a follower NPC 136 includes random noise addition. This heuristic function introduces a degree of randomness to the follower NPC's decision-making process, allowing for some variation and adaptability in their choices. In at least some implementations, one or more follower NPCs 136 do not implement a heuristic function and directly adopt the decision made by their leader NPC 136 without modification. This can lead to faster decision-making and reduced computational overhead. Also, two or more follower NPCs 136 implement the same or different heuristic.

In at least some implementations, the heuristic configuration process 308 determines which heuristic function(s) each follower NPC 136 should use based on its current situation, such as its distance from the leader NPC 136 or any specific goals it may have. The heuristic configuration process 308 then transmits this information to the follower NPCs 136, allowing them to adapt their decision-making processes accordingly. By using one or more heuristic functions in conjunction with the decisions made by their leader NPC 136, the follower NPCs 136 can effectively make informed and coordinated decisions that take into account their individual circumstances and goals.

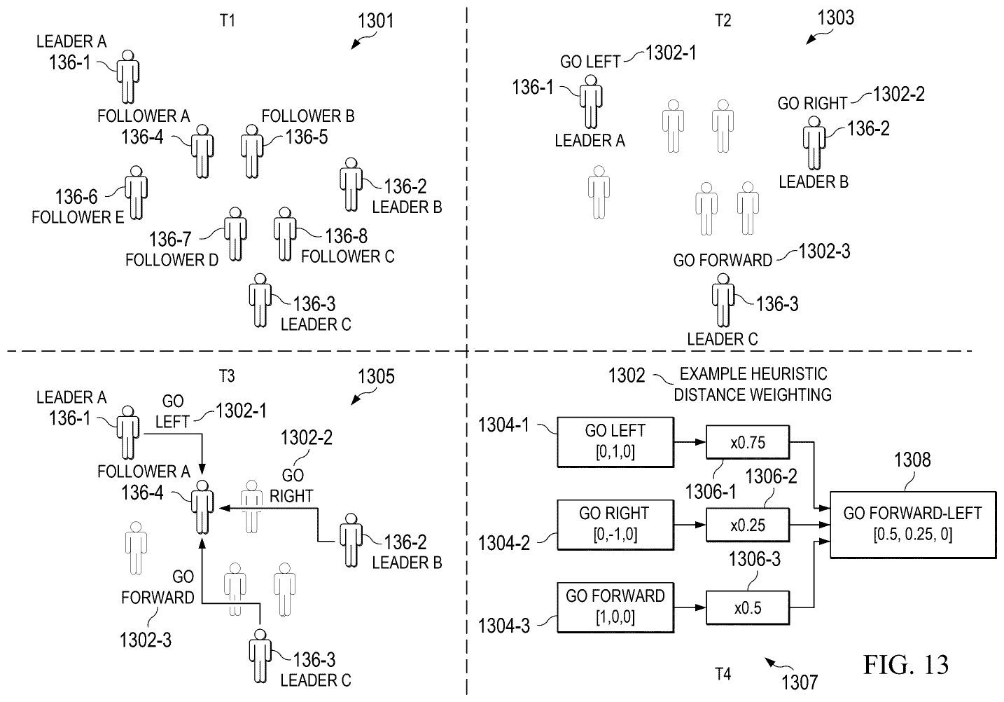

FIG. 13 shows one example the decision-making process of a group of NPCs 136 including leader NPCs 136 and follower NPCs 136. At time T1 1301, the NPC grouping process 302 groups multiple NPCs 136 into a group, and the selection process 304 selects one or more leader NPCs 136 and zero or more sub-leaders, and designates the remaining NPCs 136 as followers. In this example, three leader NPCs 136 have been selected, Leader A 136-1, Leader B 136-2, and Leader C 136-3. The remaining five NPCs 136-4 to 136-8 are follower NPCs 136. At time T2 1303, each leader NPC 136 computes their decision 1304 (e.g., selects an action) using one or more RL-based decision-making policies 146. In this example, Leader A 136-1 made the decision 1304-1 to “go left”, Leader B 136-2 made the decision 1304-2 to “go right”, and Leader C 136-3 made the decision 1304-3 to “go forward”. At time T3, the leader NPCs 136 broadcast their decisions 1304 to each of the follower NPCs 136. At time T4 1307, each follower NPC 136 uses a heuristic function to compute their own decision 1306 based on the decisions 1304 made the leader NPC.

For example, FIG. 13 shows that at least one of the follower NPCs 136-4 implements a distance weighting heuristic 1302 that applies a weight to the leaders' decisions 1304 based on the distance of the leader NPC 136 to the follower NPC 136-4. In this example, Leader A 136-1 was the closest leader NPC 136 to the follower NPC 136-4, Leader C 136-3 was the second closest leader NPC 136-4 to the follower NPC 136, and Leader B 136-2 was the farthest leader NPC 136 from the follower NPC 136-4. As such, the follower NPC 136-4 gives the most weight to the decision 1304-1 made by Leader A 136-1, the second most weight to the decision 1304-2 made by Leader B 136-2, and the least weight to the decision 1304-3 made by Leader C 136-3. In this example, the follower NPC 136-4 multiples the coordinates [0,1,0] of Leader A's decision 1304-1 by a factor 1306-1 of 0.75 resulting in coordinates of [0, 0.75, 0], multiples the coordinates [0, −1, 0] of Leader B's decision 1304-2 by a factor 1306-2 of 0.25 resulting in coordinates of [0, −0.25, 0], and multiples the coordinates [1,0,0] of Leader C's decision 1304-3 by a factor 1306-3 of 0.50 resulting in coordinates of [0.5, 0, 0]. The follower NPC 136-4 aggregates these calculations to determine its final decision 1308, which in this example is to “go forward-left” with the coordinates of [0.5, 0.5, 0].

In some instances, a follower NPC 136 may need to be promoted to a leader NPC 136 or a sub-leader NPC 136. As such, the selection process 304 (or another process) identifies situations where a follower NPC 136 should become a leader NPC 136, allowing for more autonomy and decision-making capabilities. In at least some implementations, when a follower leaves a group of NPCs 136 and is now the only one left in that particular area, the selection process 304 promotes this NPC 136 to a leader. For example, consider a 3-way fork in a road causing some leaders to go left and right, while an NPC 136 in the middle decides to go straight. In this scenario, the middle NPC 136 is promoted to a leader to make its own decision, rather than following the previous group's decisions. In at least some implementations, if a group has too few leaders, the selection process 304 promotes one or more followers to leaders. This can help distribute decision-making responsibilities and prevent the group from behaving in an unnatural way. For instance, if only one leader is present in a large group, it could lead to uncanny behavior that detracts from the overall gaming experience. In at least some implementations, when a group is splitting into multiple smaller groups, the selection process 304 promotes followers to leaders to help maintain a more realistic representation of NPCs 136. This might occur when a group elongates before NPCs 136 at the front and back diverge, requiring new leaders to emerge in each subgroup. In at least some implementations, if combining leader decisions no longer yields a reasonable decision, the selection process 304 promotes some followers to leaders. For example, if a leader NPC responds aggressively to the player because they are in close proximity, entities at the back of the crowd should not react similarly. In this case, promoting some followers to leaders can help prevent this kind of unnatural behavior.

In some instances, a leader NPC 136 may need to be demoted to a follower NPC 136. As such, the selection (or another) process 304 identifies situations where a leader NPC 136 should become a follower NPC 136, allowing for more controlled and predictable decision-making processes. In at least some implementations, when NPCs 136 that were not part of a group suddenly find themselves in close proximity, the selection process 304 forms a new group and demotes some or all of these NPCs 136 from leaders to followers. This can help prevent overrepresentation in certain groups and maintain a more natural distribution of computation over the groups of NPCs 136. In at least some implementations, if the environment 134 is performing poorly due to too many leader NPCs 136 requesting decisions, the selection process 304 demotes some leaders to followers to help alleviate this burden. By reducing the number of leader NPCs 136 making decisions, overall performance is improved.

As such, the techniques and implementations described herein enable more effective and coordinated decision-making processes in groups or crowds of NPCs. By using heuristic functions that take into account individual circumstances and goals, follower NPCs can make informed decisions that align with their leader's choices. This allows for more realistic and natural behavior, such as adapting to changing situations or responding to different threats. Furthermore, the adaptive techniques also help conserve computational resources by reducing the need for complex decision-making processes. In traditional NPC group behaviors, each NPC may need to perform a separate decision-making process, which can be computationally expensive. By leveraging leader NPCs and heuristic functions, the invention reduces the number or complexity of ML-based decision-making processes required, thereby freeing up computational resources for other tasks or more complex behaviors. This efficient use of computing power enables the creation of more sophisticated and engaging NPC interactions without sacrificing performance or overall system integrity.

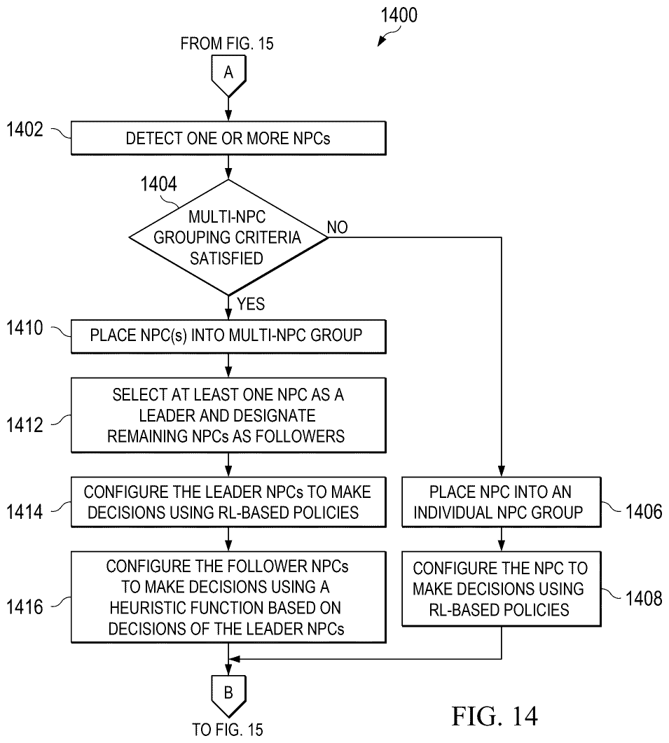

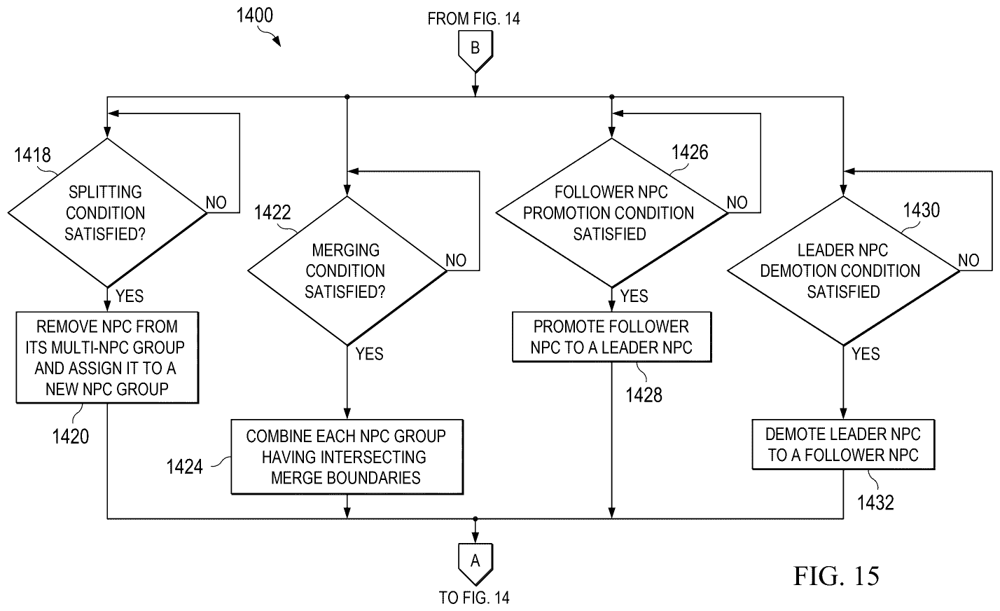

FIG. 14 and FIG. 15 together are a diagram illustrating an example method 1400 of an overall process for managing NPCs 136 in a virtual digital environment 134 in accordance with at least some implementations. It should be understood that the processes described below with respect to method 1400 have been described above in greater detail with reference to FIG. 1 to FIG. 13. For purposes of description, the method 1400 is described with respect to an example implementation at the processing system 100 of FIG. 1, but it will be appreciated that, in other implementations, the method 1400 is implemented at processing devices having different configurations. Also, the method 1400 is not limited to the sequence of operations shown in FIG. 14 and FIG. 15, as at least some of the operations can be performed in parallel or in a different sequence. Moreover, in at least some implementations, the method 1400 can include one or more different operations than those shown in FIG. 14 and FIG. 15.

At block 1402, the NPC managing circuit 152 detects one or more NPCs 136 in the virtual digital environment 134. At block 1404, the NPC managing circuit 152 determines if at least one characteristic, attribute, or a combination thereof of the NPC(s) 136 satisfies one or more multi-NPC grouping criteria. Examples of NPC characteristics or attributes include spawn location, spawn time, spawn proximity to other NPCs, NPC type, etc. Examples of multi-NPC grouping criteria include NPC spawn time thresholds, NPC spawn location, NPC spawn proximity thresholds, and the like. As an example, the NPC managing circuit 152 determines if the NPC(s) 136 was spawned within a threshold amount of time to at least one other NPC 136 and within a threshold proximity of at least one other NPC.

At block 1406, in response to the one or more multi-NPC grouping criteria failing to be satisfied, the NPC managing circuit 152 places the NPC 136 into an individual NPC group with the NPC 136 being the only member of this group. As indicated above, the individual NPC group is defined by a merge boundary. However, in some instances, an individual NPC group also includes a splitting boundary similar to a multi-NPC group. At block 1408, the NPC managing circuit 152 configures the NPC 136 in the individual NPC group to makes decisions (e.g., select and perform an action) using RL-based policies 146 or other ML-based or AI-based policies. The flow then proceeds to block 1418.

At block 1410, in response to the one or more multi-NPC grouping criteria being satisfied, the NPC managing circuit 152 groups the NPC 136 with at least one NPC 136 to form a multi-NPC group, or adds the NPC 136 to an already existing multi-NPC group. As indicated above, the multi-NPC group is defined by an outer splitting boundary and an inner merge boundary. At block 1412, the NPC managing circuit 152 selects at least one NPC 136 in the multi-NPC group as a leader and designates the remaining NPCs 136 in the multi-NPC group as followers. At block 1414, the NPC managing circuit 152 configures the leader and any sub-leader NPC(s) 136 to make decisions (e.g., select and perform an action) using RL or other ML-based policies 146 or other AI-based techniques, such as behavior trees. At block, 1416, the NPC managing circuit 152 configures the follower and any sub-leader NPC(s) 136 to use one or more heuristic functions to make their decisions based on the decisions of the leader NPC(s) 136.

After the one or more NPC groups and their NPCs 136 have been configured, the NPC managing circuit 152 monitors for various conditions in sequence or in parallel, as shown in FIG. 15. For example, at block 1418, the NPC managing circuit 152 determines if a splitting condition has been satisfied. For example, the NPC managing circuit 152 determines if the current position of any NPC 136 in a multi-NPC group is outside of the splitting boundary of the multi-NPC group. Another example of a splitting condition includes a split property computed on one or more leader NPCs 136. If no splitting conditions have been satisfied, the managing circuit 152 continues to monitor for a splitting condition. At block 1420, in response to a splitting condition being satisfied, the NPC managing circuit 152 removes the NPC 136 from its multi-NPC group and assigns the NPC 136 either to its own individual NPC group, a new multi-NPC group, or to a different existing multi-NPC group. For example, if no other NPCs 136 from the multi-NPC group moved outside of the splitting boundary or are beyond a proximity threshold from the NPC 136, the NPC managing circuit 152 assigns the NPC 136 to an individual NPC group. However, if the proximity of the NPC 136 is within a threshold distance to another NPC that moved outside of the splitting boundary of the multi-NPC group, the NPC managing circuit 152 places these NPCs into a new multi-NPC group. In another example, if the NPC 136 has moved into the merge boundary of an another multi-NPC group, the NPC managing circuit 152 adds the NPC 136 to this multi-NPC group. If the NPC 136 has moved into the merge boundary of an individual NPC group, the NPC managing circuit 152 places these two NPCs 136 into a new multi-NPC group. The flow then returns to block 1402 (or another block).

At block 1422, the NPC managing circuit 152 determines if a merging condition has been satisfied. For example, the NPC managing circuit 152 determines a merging boundary of one NPC group has intersected with the merging boundary of another NPC group. If no merging conditions have been satisfied, the NPC managing circuit 152 continues to monitor for a splitting condition. At block 1424, in response to a merging condition being satisfied, the NPC managing circuit 152 combines each of the NPC groups having intersecting merging boundaries into a single multi-NPC group, adjusting the assignment of leader NPCs as needed.

At block 1426, the NPC managing circuit 152 determines if a follower NPC promotion condition has been satisfied. Examples of NPC promotion conditions include a follower NPC leaving a group and is the only NPC within a threshold radius, the number of leader NPCs is below a threshold for the size of the group, the aggregation of leader decisions is resulting in unreasonable follower decisions, a combination thereof, and the like. If no follower NPC promotion conditions have been satisfied, the managing circuit 152 continues to monitor for follower NPC promotion conditions. At block 1428, in response to a follower NPC promotion condition having been satisfied, the NPC managing circuit 152 promotes at least one follower NPC in an NPC group to a leader.

At block 1430, the NPC managing circuit 152 determines if a leader NPC demotion condition has been satisfied. Examples of NPC demotion conditions include an NPC 136 in an individual group being merged with at least one other NPC group, poor performance of the virtual digital environment 134 due to there being too many leader NPCs 136, a combination thereof, and the like. If no leader NPC demotion conditions have been satisfied, the managing circuit 152 continues to monitor for leader NPC emotion conditions. At block 1432, in response to a leader NPC promotion condition having been satisfied, the NPC managing circuit 152 Demotes at least one leader NPC in an NPC group to a follower. The process then returns to block 1402 (or another block).

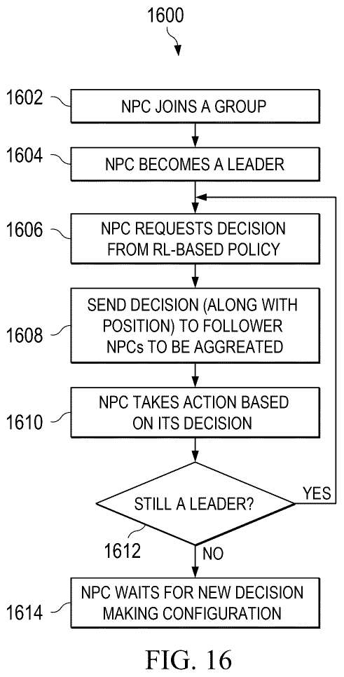

FIG. 16 is a diagram illustrating an example method 1600 of a leader NPC making decisions in a virtual digital environment 134 in accordance with at least some implementations. It should be understood that the processes described below with respect to method 1600 have been described above in greater detail with reference to FIG. 1 to FIG. 13. The method 1600 is not limited to the sequence of operations shown in FIG. 16, as at least some of the operations can be performed in parallel or in a different sequence. Moreover, in at least some implementations, the method 1600 can include one or more different operations than those shown in FIG. 16.

At block 1602, an NPC 136 joins a group of NPCs. At block 1604, the NPC 136 is selected as a leader of the NPC group. At block 1606, the NPC 136 requests decisions from an RL-based policy 146 or other ML-based or AI-based policy. At block 1608, the NPC 136 sends its decision(s) and, in at least some implementations, its position to each follower NPC 136 of its NPC group. At block 1610, the NPC 136 takes an action based on its decision. At block 1612, the NPC 136 determines if it is still a leader NPC. If the NPC 136 is still a leader NPC 136, the flow returns to block 1606. At block 1614, if the NPC 136 is no longer a leader, the NPC 136 waits for a new decision making configuration. For example, the NPC 136 waits for the NPC managing circuit 152 to configure it to make decisions as a follower NPC or as a leader NPC for a new NPC group. The flow then ends or returns to another block, such as block 1602.

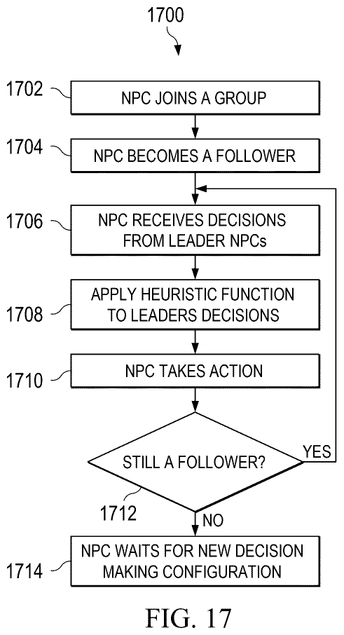

FIG. 17 is a diagram illustrating an example method 1700 of a follower NPC making decisions in a virtual digital environment 134 in accordance with at least some implementations. It should be understood that the processes described below with respect to method 1700 have been described above in greater detail with reference to FIG. 1 to FIG. 13. The method 1700 is not limited to the sequence of operations shown in FIG. 17, as at least some of the operations can be performed in parallel or in a different sequence. Moreover, in at least some implementations, the method 1700 can include one or more different operations than those shown in FIG. 17.

At block 1702, an NPC 136 joins a group of NPCs. At block 1704, the NPC 136 is selected as a follower of the NPC group. At block 1706, the NPC 136 receives decisions one or more leader NPCs 136 of the NPC group. At block 1708, the NPC 136 aggregates all leader decisions and applies one or more heuristic functions to the aggregated decisions to determine its own decision. At block 1710, the NPC 136 takes an action based on its decision. At block 1712, the NPC 136 determines if it is still a follower NPC 136. If the NPC 136 is still a follower NPC, the flow returns to block 1706. At block 1714, if the NPC 136 is no longer a leader, the NPC 136 waits for a new decision making configuration. For example, the NPC 136 waits for the NPC managing circuit 152 to configure it to make decisions as a leader NPC or as a follower NPC for a new NPC group. The flow then ends or returns to another block, such as block 1702.

One or more of the elements described above is circuitry designed and configured to perform the corresponding operations described above. Such circuitry, in at least some implementations, is any one of, or a combination of, a hardcoded circuit (e.g., a corresponding portion of an application-specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components”, “units”, “devices”, “circuitry”, etc.) are described or claimed as “configured” to perform one or more tasks or operations. This formulation of [entity] configured to [perform one or more tasks] is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to”. An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method comprising:
responsive to assigning a plurality of non-playable characters (NPCs) in a virtual digital environment to a first NPC group, selecting one or more NPCs of the plurality of NPCs as at least one leader NPC and designating remaining NPCs of the plurality of NPCs as follower NPCs;
configuring the at least one leader NPC to make decisions using a machine learning-based policy; and
providing a decision made by the at least one leader NPC to the follower NPCs.

2. The method of claim 1, further comprising:
configuring each of the follower NPCs to make decisions using at least one heuristic function based on the decision provided for the at least one leader NPC or a decision of one or more NPCs of the plurality of NPCs designated as a sub-leader.

3. The method of claim 2, further comprising:
updating the virtual digital environment based on at least one of:
the decision made by the at least one leader NPC,
the decision of the one or more NPCs designated as a sub-leader, or
decisions made by the follower NPCs.

4. The method of claim 2, wherein configuring each of the follower NPCs comprises:
configuring each of the follower NPCs to apply a different weight to the provided decision of each of the at least one leader NPC based on one or more attributes of each of the at least one leader NPC in relation to the follower NPC.

5. The method of claim 1, wherein the machine learning-based policy is one of a reinforcement learning-based policy, a large language model-based policy, or an offline machine-learning based policy.

6. The method of claim 1, further comprising:
responsive to an NPC of the plurality of NPCs having moved outside of a splitting boundary of the first NPC group, removing the NPC from the first NPC group and assigning the NPC to a second NPC group.

7. The method of claim 6, wherein the second NPC group is a new NPC group or an existing NPC group and is one of a multi-NPC group or a single-NPC group.

8. The method of claim 1, further comprising:
responsive to a merge boundary of the first NPC group intersecting with a merge boundary of a second NPC group, combining the first NPC group and the second NPC group into a third NPC group.

9. The method of claim 1, further comprising:
responsive to detecting an NPC promotion condition, promoting at least one of:
one or more of the follower NPCs to a leader NPC, or
one or more NPCs of the plurality of NPCs designated as a sub-leader to a leader NPC.

10. The method of claim 1, further comprising:
responsive to detecting an NPC demotion condition demoting the at least one leader NPC to a follower NPC.

11. A processing system, comprising:
a plurality of hardware components; and
a non-playable character (NPC) management circuit configured to:
responsive to a plurality of NPCs in a virtual digital environment being assigned to a first NPC group, select one or more NPCS of the plurality of NPCs as at least one leader NPC and designating remaining NPCs of the plurality of NPCs as follower NPCs;
configure the at least one leader NPC to make decisions using a machine learning-based policy; and
provide a decision made by the at least one leader NPC to the follower NPCs.

12. The processing system of claim 11, wherein the NPC management circuit is further configured to:
configure each of the follower NPCs to make decisions using at least one heuristic function based on the decision provided for the at least one leader NPC or a decision of one or more NPCs of the plurality of NPCs designated as a sub-leader.

13. The processing system of claim 12, wherein at least one of the hardware components of the plurality of hardware components is configured to:
update the virtual digital environment based on at least one of:
the decision made by the at least one leader NPC,
the decision of the one or more NPCs designated as a sub-leader, or
decisions made by the follower NPCs.

14. The processing system of claim 12, wherein the NPC management circuit is configured to configure each of the follower NPCs by:
configuring each of the follower NPCs to apply a different weight to the provided decision of each of the at least one leader NPC based on one or more attributes of each of the at least one leader NPC in relation to the follower NPC.

15. The processing system of claim 11, wherein the NPC management circuit is further configured to:
responsive to an NPC of the plurality of NPCs having moved outside of a splitting boundary of the first NPC group, remove the NPC from the first NPC group and assigning the NPC to a second NPC group.

16. The processing system of claim 15, wherein the second NPC group is a new NPC group or an existing NPC group and is one of a multi-NPC group or a single-NPC group.

17. The processing system of claim 11, wherein the NPC management circuit is further configured to:
responsive to a merge boundary of the first NPC group intersecting with a merge boundary of a second NPC group, combine the first NPC group and the second NPC group into a third NPC group.

18. The processing system of claim 11, wherein the NPC management circuit is further configured to:
responsive to detection of an NPC promotion condition, promote at least one of:
one or more of the follower NPCS to a leader NPC, or
one or more NPCs of the plurality of NPCs designated as a sub-leader to a leader NPC.

19. The processing system of claim 11, wherein the NPC management circuit is further configured to:
responsive to detecting an NPC demotion condition, demote the at least one leader NPC to a follower NPC.

20. A method comprising:
obtaining, by a first non-playable character (NPC) in a virtual digital environment, a first decision made by a second NPC based on a machine learning-based policy and a second decision made by a third NPC based on a machine learning-based policy;
responsive to applying, by the first NPC, a heuristic function to each of the first decision and the second decision, generating a third decision for the first NPC; and
updating the virtual digital environment based on at least one of the first decision, second decision, or the third decision.
